(19) United States
(12) Patent Application Publication
(10) Pub. No.: US 2010/0239797 A1
(43) Pub. Date: Sep. 23, 2010

(54) Flexible Multi-Layer Material, Preferably for an Inflatable Balloon Casing, and Method for the Production of an Inflatable Casing

(76) Inventor: Kamal Alavi, Walchwil (CH)

Correspondence Address: BRIAN ROFFE, ESQ, 75 WOOD LANE, WOODSBURGH, NY, 11598, US

(21) Appl. No.: 12/597,545

(22) PCT Filed: Apr. 25, 2008
(86) PCT No.: PCT/EP08/03347

§ 371 Date: May 3, 2010

(30) Foreign Application Priority Data
Apr. 28, 2007 (CH) 00702/07

(51) Int. Cl. B32B 1/02; B32B 9/04; B32B 27/08; B32B 15/08; B32B 27/32; B32B 38/18

(52) U.S. Cl. 428/35.3; 428/411.1; 428/516; 428/523; 428/476.9; 156/190

(57) ABSTRACT

The invention relates to a flexible multi-layer material that can be used in particular for an inflatable balloon casing, a blimp, an airbag, a sail, a flexible solar cell, or a flexible antenna. At least one layer (11, 13) is provided, which is particularly made of ultra high molecular weight polyethylene (UHMWPE), or of ultra high molecular weight polypropylene (UHMWPP). The same is surrounded on each of the two sides by a layer, or a film (10, 12; 12, 14) made of polyethylene or polypropylene, and connected thereto, wherein the layers, or films (10-14) placed on top of each other can be connected to each other by means of heating. Such a material layer is lightweight and has high stability, or tear resistance, and a high modulus of elasticity.

The invention relates to a flexible multi-layer material, in particular for an inflatable balloon casing, a blimp, an airbag, a sail, a flexible solar cell, or a flexible antenna, and to a method for the production of an inflatable casing.

It is known to produce the casing for gas-filled balloons which are used, for example, for positioning various telecommunications and/or observation platforms in the stratosphere (high altitude balloons) from a material made up from a number of layers with which e.g. a layer or a film of Mylar (polyethylene terephthalate, PET), and to this a further polyethylene layer or a further polyethylene film are applied. Here the individual layers are connected to each other by means of appropriate adhesives. The balloon casing is generally produced from a plurality of strips made up from the multi-layer material which are also adhesively bonded to each other. This is associated with several disadvantages. At the adhesion points there is always the risk that the latter will become non-tight, and so the gas filling the balloon, e.g. helium or hydrogen, can escape. They also have a negative impact upon the flexibility and the required high stability or tear resistance of the balloon casing, and not least they also increase the weight of the casing. Specifically with the balloons positioned at heights of 20 to 30 km (high altitude balloons) which are subjected to extreme temperature differences and in particular also e.g. temperatures of −80° C., the adhesion points constitute a risk factor.

The object which forms the basis of the present invention is to provide a multi-layer material, in particular for an inflatable balloon casing, but also for example for blimps, parachutes, airbags, sails, flexible solar cells or the like, which is light and has a high E-module and high stability or tear resistance. Furthermore, a method for the production of an inflatable casing made of the multi-layer material according to the invention is proposed with which one largely dispenses with the adhesion of individual layers and strips associated with disadvantages, and a light, flexible casing which also withstands high pressure under different conditions, e.g. a balloon, blimp or airbag casing can be produced.

This object is achieved according to the invention by means of a multi-layer material with the features of Claim 1 and by means of a method according to Claim 10.

Preferred further embodiments of the multi-layer material according to the invention and of the method according to the invention form the subject matter of the dependent claims.

The flexible multi-layer material according to the invention is characterised due to the at least one layer of ultra high molecular weight polyethylene (UHMWPE) or of ultra high molecular weight polypropylene (UHMWPP) by high tear resistance. Due to the fact that this UHMWPE layer is surrounded on each of the two sides by a layer or a film made of polyethylene (or the UHMWPP layer by a respective layer or film made of polypropylene), the layers or films placed on top of each other can be connected to each other purely by means of heating without adhesives having to be used.

With the method according to the invention an inflatable casing, e.g. a balloon casing, can be formed around an inflated mould casing practically like a “high-pressure storage tank”, the individual layers or films being unrolled one after the other and then being heated by means of a heating roller and in this way being connected to each other. Preferably the layers or films are wound and rolled onto the inflated mould casing in a coil shape and overlapping. Advantageously the layers or films are rolled onto a mould casing rotating about its longitudinal axis by means of a roller moved along the mould casing, the heating roller also being moved along the rotating mould casing. After completion of the casing the mould casing is emptied and pulled out from the casing through a closeable opening provided for this purpose.

In the following the invention will be explained in greater detail by means of the drawings. The latter show, purely diagrammatically, as follows:

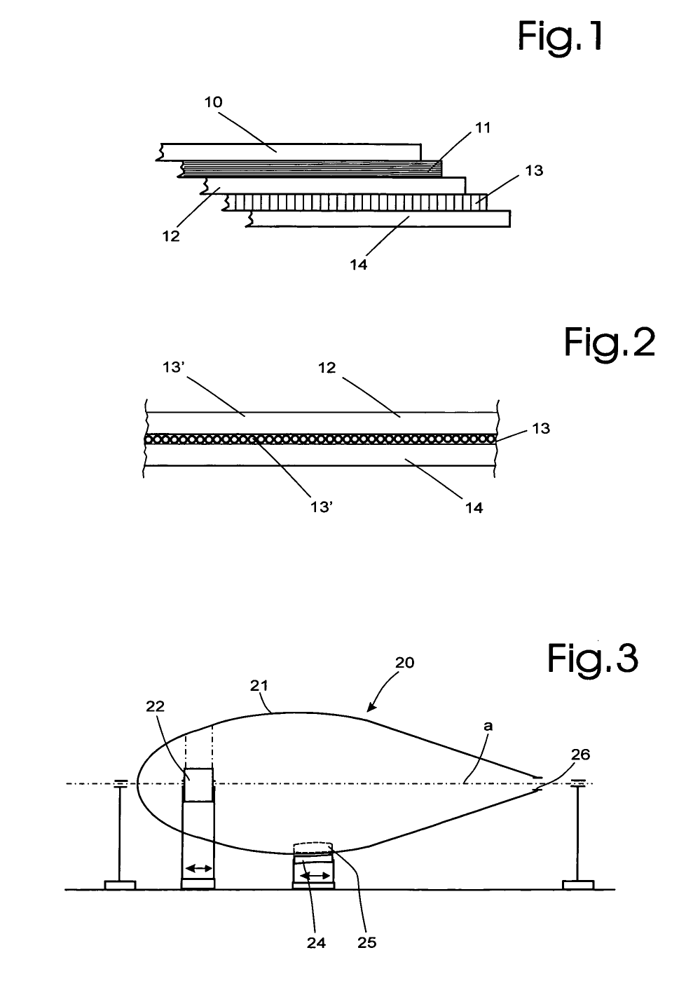

FIG. 1 is an exemplary embodiment of the structure and of the layer composition of a multi-layer material according to the invention;

FIG. 2 is an enlarged partial cross-section of the multi-layer material according to the invention;

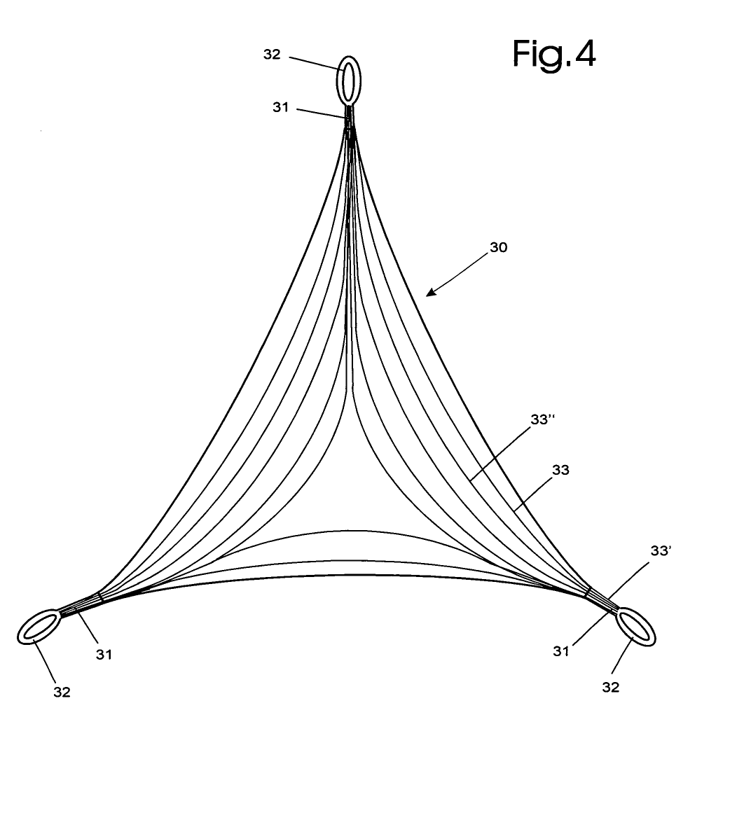

FIG. 3 is an arrangement for the production of an inflatable balloon casing made of the multi-layer material according to the invention; and

FIG. 4 is a front view of a sail made of the multi-layer material according to the invention.

In FIG. 1, it is shown diagrammatically which layers, according to the invention, can make up a flexible multi-layer material provided, for example, for an inflatable balloon or blimp casing.

An exemplary embodiment is indicated with five layers 10 to 14. A first layer 10, which is to form the inside of the balloon, is formed by an ethylene-based film, for example ethylene vinyl alcohol (EVOH), which is approximately 5 to 20 μm thick. To this first layer or film 10 a layer 11 of ultra high molecular weight polyethylene (UHMWPE) is applied, this possibly being, for example, a commercially available material made up from fibres, threads or the like, such as Dyneema or Spectra. Between this layer 11 and a further UHMWPE layer 13, preferably also made up from Dyneema fibres or threads, an intermediate layer 12 of low density polyethylene (LLPPE) is provided which is approximately 8 μm thick. The second UHMPWE layer 13 is finally to be covered with a further LDPE polyethylene film 14 which can be provided on the outside with an aluminium protective layer.

Moreover, on the inside of the balloon the inner layer 10 could be provided with an additional powder coating in the nano range by applying plasma or the like.

Due to the presence of the two UHMWPE layers 11, 13 extremely high stability or tear resistance of the material is achieved, in particular if the fibres or threads of the one UHMWPE layer 11 extend laterally to the fibres or threads of the other UHMWPE layer 13, as indicated in FIG. 1. In theory, however, just one UHMWPE layer could also be provided as reinforcement. It is not necessary for these fibres or threads to be surface treated, but in principle they could be, for example by means of a plasma method. These layers 13 are made up from a number of fibre strands or threads, placed next to one another regular distances apart, and which are respectively composed of a plurality of individual fibres. These threads have a specific weight of 50 to 2300 g/10000 m. For the present application a weight of 110 g/10000 m is preferably used. With these Dyneema fibres average stability values of up to 2,000 N/mm² (tensile loads) are achieved.

Due to the fact that this at least one UHMWPE layer is surrounded on each of the two sides by a layer or a film made of polyethylene, the layers or films placed on top of each other can be connected to each other purely by means of heating without adhesives or resin mixtures having to be used. Here the layers are heated to a temperature just below the melting point, preferably to 60-90° C. in the compressed state. Particularly suitable as polyethylene films are stretch films by means of which self-adhesion is already brought about upon joining to the layer 13 made up from fibres or threads.

Instead of UHMWPE ultra high molecular weight polypropylene (UHMWPP) could also form a corresponding layer or layers 11, 13, instead of the usual polyethylene layers or films, layers or films made of polypropylene (propylene) then correspondingly having to be used. Polypropylene is particularly suitable for applications at ambient temperatures because polypropylene can only be used at up to approx. −20° C.

FIG. 2 shows in an enlarged illustration a cross-section in particular through the layer 13 with the fibres or threads 13′. These threads 13′, which respectively have a diameter in the micrometer range, are arranged such that they are located approximately in a row, not lying over one another, and parallel to one another so that each individual thread 13′ is connected on both sides to the respective film 12, 14. Therefore an optimal whole surface connection is produced between the films and the fibres or threads. For this purpose the threads, which are generally provided in clusters, are separated from one another and aligned to form an approximately single row layer 13 before they are then joined together with the films and stuck.

It is now explained by means of FIG. 3 how, for example, a casing, e.g. a balloon casing, is produced from the multi-layer material described above.

FIG. 3 shows an arrangement 20 with a mould casing 21 corresponding to the external form of the balloon casing to be produced, preferably inflated into an aerodynamic form, which is preferably made of a material which can not fuse with polyethylene, preferably a textile. The moulding casing 21 is mounted in the arrangement 20 such as to rotate about its longitudinal axis a. According to the invention the first layer 10, preferably formed by the gas-tight ethylene vinyl alcohol film (EVOH), is first of all rolled onto the inflated mould casing 21 in a coil shape and overlapping, for which purpose a roller 22 moved along the mould casing 21 is provided. After this, by means of a heating roller 24 also moved along the mould casing 21, to which a magnetically entrained counter-roller 25 is assigned within the mould casing 21, the first layer 10 is heated and the overlapping film parts are pressed against one another and are thus connected to one another in a gas-tight manner. Advantageously these joined together films are immediately cooled after this so that the molecular structure of the fibres is not changed.

Next the further layers or films are rolled individually one after the other onto the moulding casing. Here the two UHMWPE or Dyneema layers 11, 13 are wound such that the fibres or threads of the two layers extending laterally to one another are aligned to the longitudinal or rotational axis a of the mould casing 21. For this purpose the axis of rotation a of the mould casing 21 can at all events be positioned at an angle to the direction of travel of the moveable roller 22.

After the last polyethylene film 14 has been rolled onto the casing, by means of the heating roller 24 all of the layers or films 10 to 14 are connected to each other by heating so that a type of “one-piece high-pressure storage tank” is formed around the inflated mould casing 21. After completion of this balloon casing the air is let out of the mould casing 21 and the latter is pulled out from the balloon casing through a closeable opening 26 provided for this purpose.

Before emptying and pulling out the mould casing 21 a teflon layer (FEP) can additionally be stuck onto the balloon casing as UV protection, preferably by means of an acrylic adhesive 966.

The balloon casing produced according to the invention is thin and light, and it can nevertheless withstand extremely high pressure loads, even with changing conditions. It is advantageous if the individual films can be wrapped with different overlapping at different points so that the casing can be formed with different strengths at different points. Due to the aforementioned properties of the casing a balloon can be brought to greater heights than is possible with conventional balloon casings.

Similarly to the balloon casings, blimp or airbag casings could also be produced. With an airbag casing the first layer, to which the further layers or films are applied, is advantageously formed by means of a polyethylene film coated on the side corresponding to the inside of the airbag casing with aluminium. Due to the multi-layer material according to the invention a higher pressure can be used, the airbag being sufficiently flexible, however, due to the high E-module of the material when subjected to impact.

Instead of casings, products such as sails, flexible solar cells, flexible antennae and similar could also be produced from the material according to the invention. Depending on the form of the product to be produced the first layer or film is then applied to a direct mould surface or one having a corresponding negative form, for example sucked in, before the further layers, of which again at least one is made of UHMWPE or UHMWPP, and connected to each other by heating.

When used as a sail, advantageously one of the layers surrounding the UHMWPE layer is made of a nylon 66 coated with polyethylene (PE) in order to increase stability. Nevertheless, the sail is substantially lighter than conventional sails made of nylon and are therefore better to handle. As an alternative, with a sail a covering film with an outer aluminium protective layer can also be used.

Moreover, with the material according to the invention a further problem can be resolved, as is indicated with the sail 30 in FIG. 4. Until now, it was always at the tying points provided with openings for attachment means where tears occurred. According to the invention fibres or threads 31 of the UHMWPE or UHMWPP layer or layers from the material layers placed on top of each other or and connected to each other, which form the sail surface 30′, protrude and are used as means for attaching the sail 30.

The fibres or threads 31 can then e.g. also be formed into loops 32 with which these fibres or threads 31 pass out of the sail and are introduced back into the sail, as illustrated with the thread 33, 33′, 33″. Therefore an optimal force transition from the sail 30 to these cords holding the latter is produced. In the part protruding from the sail these threads could, for example, be plaited to form a sail. Moreover, fibres or threads could also be provided in the lateral direction.

Bullet-proof items of clothing, flexible solar cells and batteries, bullet-proof coverings for helicopters, flexible tubes, balloons in the surgical field with high-pressure catheters for arteriosclerotic vessel openings and others are also conceivable as further uses of this multi-layer material according to the invention.

In principle the respective layer of fibres or threads could be composed of different synthetic materials, for example UHMWPE and UHMWPP so that on the one side of the layer made up from fibres or threads a layer or film of a different material could be connected opposite the layer on the other side by heating.

1. A flexible, multi-layer material, preferably for an inflatable balloon casing, a blimp, an airbag, a sail, a flexible solar cell, a flexible antenna or for other applications, characterised by at least one layer (11, 13) of fibres or threads made of a synthetic with a high tear resistance and at least one layer or film (10, 12; 12, 14) connectable to the latter and made of a synthetic, the latter being made of a material such that it can essentially be connected to the layer (11, 13) produced from fibres or threads made of a synthetic by heating.

2. The multi-layer material according to claim 1, characterised in that the fibres or threads of the layer (11, 13) are produced from ultra high molecular weight polyethylene (UHMWPE) and are surrounded on each of the two sides by a polyethylene- or ethylene-based layer or film (10, 12; 12, 14) and can be connected to the latter by heating.

3. The multi-layer material according to claim 1, characterised in that the fibres or threads of the layer (11, 13) are produced from ultra high molecular weight polypropylene (UHMWPP) and are surrounded on each of the two sides by a polypropylene- or propylene-based layer or film (10, 12; 12, 14) and can be connected to the latter by heating.

4. The multi-layer material according to claim 2, characterised in that two UHMWPE layers (11, 13) with a common intermediate layer formed by a polyethylene film (12) or two UHMWPP layers with a common intermediate layer made of polypropylene are provided.

5. The multi-layer material according to claim 2, characterised in that Dyneema can be used as UHMWPE layers (11, 13), fibres or threads of the one UHMWPE layer (11) extending laterally to fibres or threads of the other UHMWPE layer (13).

6. The multi-layer material according to claim 1, characterised in that the layer (11, 13) is respectively formed from a number of fibre strands or threads (13′) laid next to one another which are respectively composed of a plurality of individual fibres or threads (13′).

7. The multi-layer material according to claim 1, characterised in that the threads (13′) of the layer (11, 13), which respectively have a diameter in the micrometer range, are arranged such that they are located approximately in a row in relation to one another, not lying over each other, so that after heating almost every individual thread (13′) is connected on both sides to the respective film (12, 14).

8. The multi-layer material according to claim 2, in particular for a balloon or blimp casing, characterised in that the first layer (10) forming the inside of the balloon casing is in the form of an ethylene vinyl alcohol film (EVOH) to which the one UHMWPE layer (11) made of Dyneema fibres or threads is applied, to this UHMWPE layer (11) the intermediate layer or film (12) made of low density polyethylene (LDPE), and to the latter the other UHMWPE layer (13) made of Dyneema fibres or threads being applied, and the latter being covered by a polyethylene film (14) coated on the outside with aluminium.

9. The multi-layer material according to claim 8, characterised in that an additional teflon layer (FEP) is stuck to the polyethylene foil (14) coated on the outside with aluminium after the connection of all of the layers or films (10-14) by heating, preferably using acrylic adhesive 966.

10. The multi-layer material according to claim 1, in particular for an airbag casing, characterised in that the first layer, to which the further layers or films are applied, is formed by a polyethylene film coated on the side corresponding to the inside of the airbag casing with aluminium, which is provided with a powder coating in the nano range.

11. The multi-layer material according to claim 1, provided for a sail, characterised in that fibres or threads (31) of the UHMWPE and/or UHMWPP layer or layers protrude from the material layers placed on top of each other and connected to each other and which form the sail surface (30) and can be used as means for attaching the sail.

12. The multi-layer material according to claim 11, characterised in that one of the layers surrounding the UHMWPE layer is made from a nylon 66 coated with polyethylene (PE).

13. The multi-layer material according to claim 1, characterised in that the layers or foils (10-14) placed on top of each other can be connected to each other by heating to a temperature of approx. 60-90 ° C. under contact pressure.

14. The multi-layer material according to claim 1, characterised in that the layer of fibres or threads is composed of different synthetic materials, for example UHMWPE and UHMWPP, so that on the one side of the layer made up from fibres or threads, a layer or film of a different material can be connected opposite the layer on the other side by heating.

15. The multi-layer material according to claim 1, characterised in that a stretch film can be used as a polyethylene film by means of which upon joining to the layer 13 made up from fibres or threads adhesion is already brought about.

16. A method for producing an inflatable casing, in particular a balloon, blimp or airbag casing made of a flexible, multi-layer material according to claim 1, characterised in that a first layer or film made of polyethylene or polypropylene is rolled onto a mould casing (21) inflated into the desired balloon, blimp or airbag form made of a material that can not fuse with polyethylene or polypropylene, preferably a textile, after which the further layers or films are individually wound one after the other onto the casing (21) and then the layers or films are heated by means of a heating roller (24) and in this way are connected to one another to form the balloon, blimp or airbag casing surrounding the mould casing (21), after which the mould casing (21) is emptied and pulled out of the completed casing.

17. The method according to claim 16, characterised in that the layers or films are wound and rolled onto the inflated mould casing (12) in a coil shape and overlapping.

18. The method according to claim 17, characterised in that the layers or films are rolled onto the mould casing (21) rotating about its axis (a) by means of a roller (22) moved along the mould casing (21), the heating roller (24) also being moved along the rotating mould casing (21) when heating the layers or films.

19. The method according to claim 16, characterised in that already after winding the first film, the overlapping film parts are connected to one another, gas-tight, by heating.

20. The method according to claim 18, characterised in that with materials with two UHMWPE or Dyneema layers, the fibres or threads of both layers extending laterally to one another are wound or rolled at an angle to the axis of rotation (a) of the mould casing (21), it being possible to place the axis of rotation (a) of the mould casing at an angle to the direction of travel of the moveable roller (22).

21. The method according to claim 16, characterised in that the layers or films are cooled immediately after heating.
